(19) United States
(12) Patent Application Publication
(10) Pub. No.: US 2007/0058874 A1
(43) Pub. Date: Mar. 15, 2007

(54) Image data compressing apparatus and method

(75) Inventors: Sunao Tabata, Mishima-shi (JP); Nobuhiko Nakahara, Susono-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/225,196

(22) Filed: Sep. 14, 2005

(51) Int. Cl. G06K 9/36

(52) U.S. Cl. 382/239

(57) ABSTRACT

Data which needs to be retained with a high resolution and data which needs not to be retained therewith can be identified, compressed efficiently, and handled with ease. An image data compressing method, comprising dividing an input image into blocks to output blocked image data by means of a block dividing section, extracting high-resolution data from the blocked image data by means of an extracting section, compressing high-resolution data by means of a first compression section, converting the blocked image data into low-resolution data by means of a low-resolution conversion section, compressing the low-resolution data by means of a second compression section, and synthesizing first compressed data from the first compression section and second compressed data from the second compression section into a single piece of compressed data by means of a code synthesis section is provided.

### BACKGROUND OF THE INVENTION

1. Field of the Invention

The present invention relates to an image data compressing apparatus and a method, and more particularly to an apparatus and a method which are effective to be applied to an image processing apparatus such as a copying apparatus, a printing apparatus and an image reading apparatus.

2. Description of the Related Art

Since image information becomes large in capacity, the image information is usually stored and used in a manner of compression thereof. In addition, in the field of copying machines and printers, the image information has become larger in capacity than 1,200 dpi/2,400 dpi, etc., so as to output characters, etc., with high definition.

Compression techniques for processing such large-capacity data are disclosed by the following documents.

The technique disclosed by document 1 (Jpn. Pat. Appln. KOKAI Publication No. 11-312173) can store an image in which an original image is reduced in its resolution in addition to the original image. This technique utilizes the low-resolution image instead of the original image in retrieval of the image to make a large-capacity image easy to be processed.

The technique disclosed by document 2 (Jpn. Pat. Appln. KOKAI Publication No. 2004-236225) is a technique for compressing an image by using the wavelet transformation. The technique can extract only a low-resolution image to enhance its browsability by scrambling only a high-resolution image.

The technique disclosed in document 3 (Jpn. Pat. Appln. KOKAI Publishing No. 2003-338934) creates an image with characters extracted therefrom and an image with a character area removed therefrom, digitalizes the character area to perform MMR processing and resolution-converts the image with the character area removed therefrom and compresses it in a JPEG system to be efficiently compressed.

Document 4 (previous application: U.S. patent application. Ser. No. 11/019,986) is the invention previously applied by the inventor of the present invention and achieves high compression by performing reversible/irreversible mixed encoding to a high-definition image of the printer or the like.

### BRIEF SUMMARY OF THE INVENTION

Document 1, however, does not make reference to the compression itself for an image having become higher in definition. The technique disclosed by document 2 hierarchically compresses a high-definition image on a frequency axis, so that it can compress the image similarly even if the image is the high-definition image. Document 2, however, does not touch on how to compress the image in relation to its resolution.

The technique disclosed by document 3 performs adaptive compression processing for an image in consideration of its resolution and the property of the image; however, high and low resolutions are independent with each other and needed to be handled individually. The technique disclosed by document 4 makes no reference to the resolution. Document 4 makes no reference to the resolution.

An object of the present invention is to provide an image data compressing apparatus and a method which can make discrimination between data required and not required to be retrained with high resolution, efficiently compress the data and also simply handle the data.

An image data compressing apparatus according to an aspect of the present invention is basically configured to comprise: a block dividing section which divides an image to output blocked image data; an extracting section which extracts high-resolution data from the blocked image data; a first compression section which compresses the high-resolution data; a low-resolution conversion section which converts the blocked image data into low-resolution data; a second compression section which compresses the low-resolution data; and code synthesis section which synthesizes first compressed data from the first compression section and second compressed data from the second compression section into a single piece of compressed data.

An image data compressing apparatus according to another aspect of the present invention, comprises: a block dividing section which divides an image to output blocked image data; an extracting section which extracts high-resolution data from the blocked image data; a first compression section which compresses the high-resolution data; a low-resolution conversion section which converts the blocked image data into low-resolution data; a selector which selects either the blocked image data or the low-resolution data; a second compression section which compresses output data from the selector; a code synthesis section which synthesizes first compressed data from the first compression section and second compressed data from the second compression section into a single piece of compressed data; and a control section which makes the selector select blocked image when the second compression section compresses the output data at the same resolution as that of the first compression section and select a decreased resolution image when the second compression section compresses a low-resolution image.

Furthermore, an image data compressing method according to other embodiment of the present invention, comprising: dividing an input image into blocks to output blocked image data by means of a block dividing section; extracting high-resolution data from the blocked image data by means of an extracting section; compressing the high-resolution data by means of a first compression section; converting the blocked image data into low-resolution data by means of a low-resolution conversion section; compressing the low-resolution data by means of a second compression section; and synthesizing first compressed data from the first compression section and second compressed data from the second compression section into a single piece of compressed data is provided.

Additional objects and advantages of the embodiments will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a configuration example of an image processing apparatus regarding a first embodiment of the present invention;

FIG. 2 is a circuit diagram showing a configuration example of a compression section shown in FIG. 2;

FIG. 3 is a circuit diagram showing a configuration example of a high-resolution data extracting section of the compression section shown in FIG. 2;

FIG. 4 is a circuit diagram showing a configuration example of a low-resolution conversion section of the compression section shown in FIG. 2;

FIG. 5A is an explanation view explaining operations of a first compression section of the compression section shown in FIG. 2;

FIG. 5B is an explanation view explaining operations of a first compression section of the compression section shown in FIG. 2;

FIG. 6 is an explanation view explaining operations of a code synthesis section of the compression section shown in FIG. 2;

FIG. 7 is an explanation view explaining a generation example of compressed data generated from the compression section shown in FIG. 2;

FIG. 8 is a circuit diagram showing a configuration example of a decoding section of the apparatus shown in FIG. 1;

FIG. 9 is a circuit diagram showing a configuration example of an image synthesis section of the decoding section shown in FIG. 8;

FIG. 10 is an explanation view explaining an operation of the image synthesis section shown in FIG. 9;

FIG. 11A is a circuit diagram showing a configuration example of a compression section of another embodiment of the present invention;

FIG. 11B is a circuit diagram showing a configuration example of a compression section of another embodiment of the present invention;

FIG. 12A is a circuit diagram showing a configuration example of a compression section of other embodiment of the present invention;

FIG. 12B is a circuit diagram showing a configuration example of a compression section of other embodiment of the present invention;

FIG. 12C is a circuit diagram showing a configuration example of a compression section of other embodiment of the present invention;

FIG. 13 is an explanation view explaining operations of a compression section of other embodiment of the present invention;

FIG. 14 is a circuit diagram showing a configuration example of a compression section for achieving the operations shown in FIG. 13;

FIG. 15 is an explanation view explaining operations of a compression section of other embodiment of the present invention;

FIG. 16 is a block diagram showing a configuration of an image processing apparatus regarding other embodiment of the present invention; and

FIG. 17 is a circuit diagram showing a configuration example of a compression section of the apparatus shown in FIG. 16.

### DETAILED DESCRIPTION OF THE INVENTION

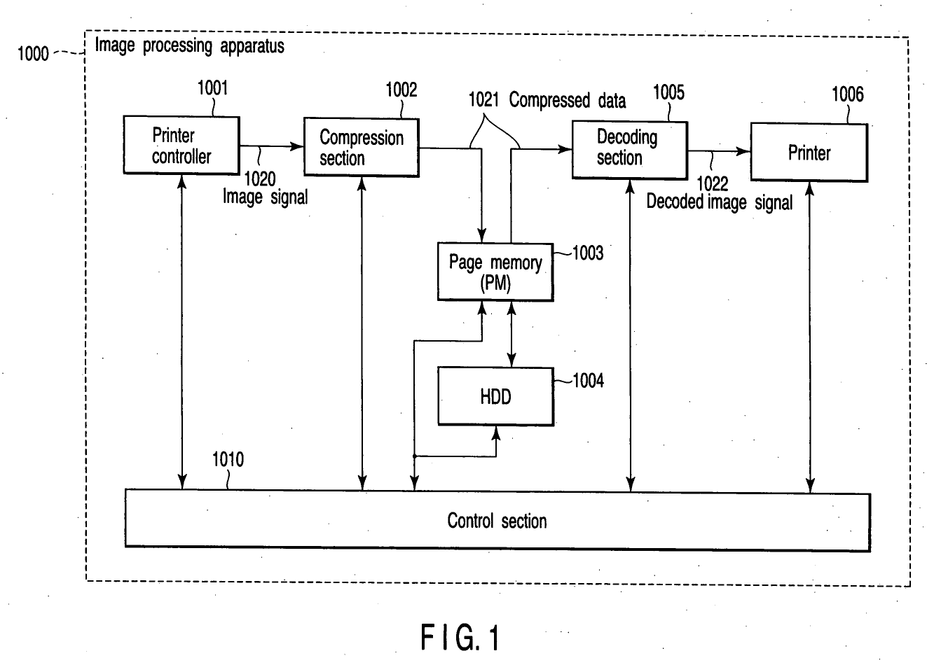

Hereinafter, embodiments of the present invention will be explained with reference to the drawings. FIG. 1 shows a function of an image processing apparatus 1000 regarding a first embodiment of the present invention by dividing the function into blocks.

A printer controller 1001 generates an image signal 1020 to be printed. A compression section 1002 compresses the generated image signal 1020 into compressed data 1021 to output it to a page memory 1003 and an HDD 1004. The page memory 1003 and the HDD 1004 for storing data can store the supplied compressed data 1021. A decoding section 1005 decodes the compressed data 1021 from the memory 1003 or the HDD 1004 to obtain a decoded image signal 1022 and outputs it to a printer 1006. The printer 1006 prints the supplied decoded image signal 1022 and outputs it.

Here, the image processing apparatus is performed overall control in a variety of above-described all operations by means of a control section 1010.

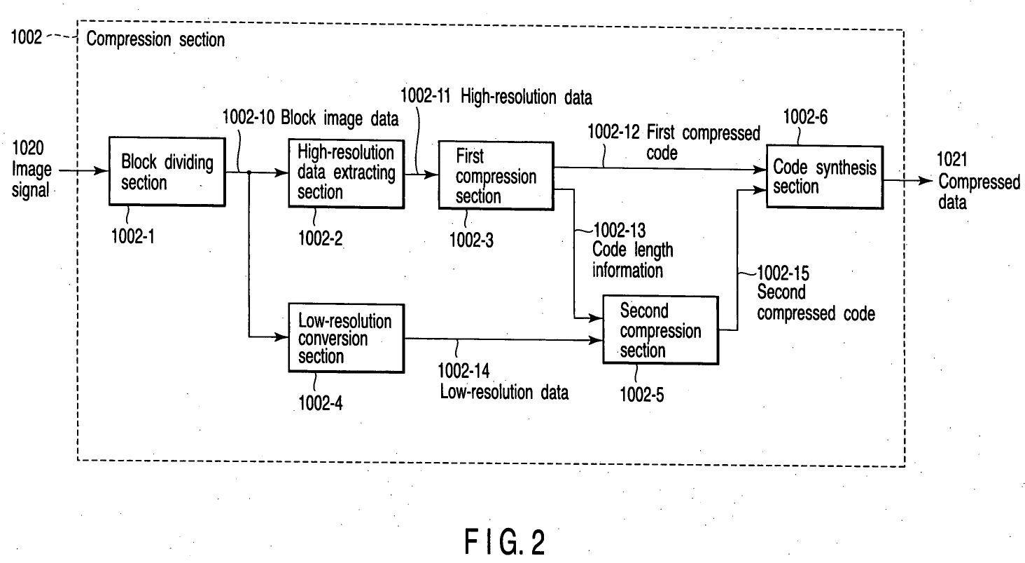

FIG. 2 shows the function of the compressing section in FIG. 1 by dividing it into blocks. The same sections as those shown in FIG. 1 are denoted by the same reference marks as those of FIG. 1.

The image signal 1020 supplied to the compression section 1002 is supplied to a block dividing section 1002-1 and divided into 16×16 pixels as block image data 1002-10 to be input to a high-resolution data extracting section 1002-2 and a low-resolution conversion section 1002-4. The extracting section 1002-2 converts the blocked image data 1002-10 supplied thereto into high-resolution data 1002-11 to supply it to a first compression section 1002-3. The low-resolution conversion section 1002-4 converts the block image data 1002-10 supplied thereto into low-resolution data 1002-14 to supply it to a second compression section 1002-5.

The first compression section 1002-3 compresses the supplied high-resolution data 1002-11 to generate a first compressed code 1102-12 and code length information 1002-13. The first compressed code 1002-12 is supplied to a code synthesis section 1002-6 and the code length information 1002-13 is supplied to the second compression section 1002-5, respectively.

The second compression section 1002-5 generates a second compressed code 1002-15 on the basis of the supplied low-resolution data 1002-14 and the code length information 1002-13. This second compressed code 1002-15 is supplied to the code synthesis section 1002-6. The code synthesis section 1002-6 synthesizes the supplied two compressed codes to output it as compressed data 1021.

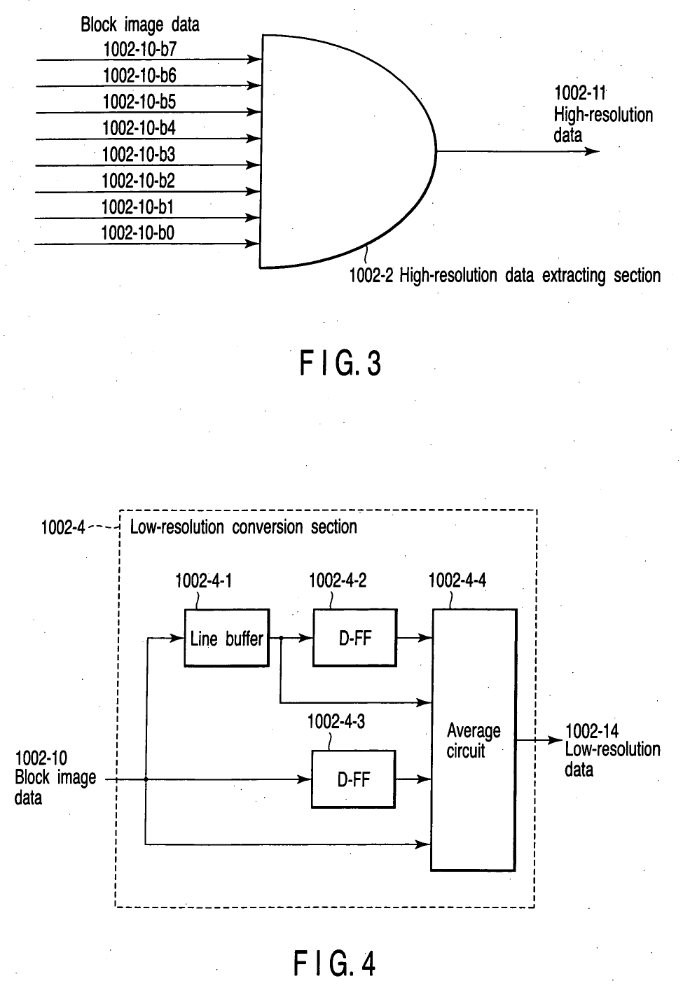

FIG. 3 shows a circuit configuration example of the high-resolution data extracting section 1002-2 shown in FIG. 2. Blocked image data 1002-10-b0 to 1002-10-b7 supplied to the high-resolution data extracting section 1002-2 is output as the high-resolution data 1002-11 through an AND circuit. That is to say, an AND operation of all bits of input data is carried out and the result is output. The high-resolution data 1002-11, of which the output is “1”, in the case that all pieces of the input data are “1” (=255), and of which the outputs are “0”, in the other cases, is output.

FIG. 4 shows the circuit configuration of the low-resolution conversion section 1002-4 in FIG. 2. A line buffer 1002-4-1 delays the data of the supplied blocked image data 1002-10 by one pixel to output it. A data flip flop (D-FF) 1002-4-2 delays the data output from the line buffer 1102-4-1 by one pixel to output it. Like this, a D-FF 1002-4-3 also delays the blocked image data 1002-10 by one pixel to output it. An average circuit 1002-4-4 receives blocked image data 1002-10 with no delay, blocked image data 1002-10 with one pixel delay, blocked image data 1002-10 with one horizontal line delay and blocked image data 1002-10 with one horizontal line delay and also one pixel delay. That is, the average circuit 1002-4-4 receives data with one pixel and four pixels (2×2 pixels) data around the one pixel.

The average circuit 1002-4-4 averages the simultaneously received data of 2×2 pixels to output it as the low-resolution data 1002-14.

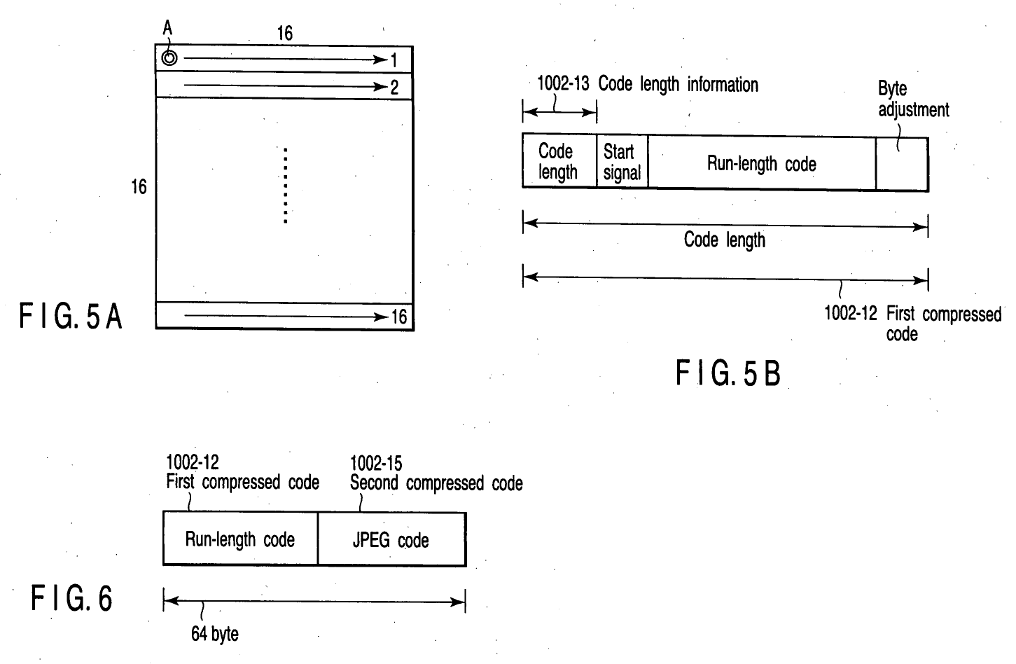

FIG. 5A is an explanation view explaining operations of the first compression section 1002-3 in FIG. 2. The first compression section 1002-3 is a run-length encoder, scans the supplied high-resolution data 1002-11 in order shown in FIG. 5A to bring it into run-length compression.

FIG. 5B is a view showing an example of a data format of data subjected to the ran-length compression. The data format is composed of a code length information area, a start signal area, a run-length code area and a byte adjusting area.

The first compressed code 1002-12 conducts compression processing by unit of 16×16 pixel blocks. The code length information 1002-13 of the run-length indicates the code length of the whole of the first compressed code 1002-12. Here, for example, 4 bytes of the first compressed code 1002-12 is described. Next, a signal (1 or 0) of an A position in FIG. 5A is described in the start signal area. Then, the run-length code is described in the run-length code area and adjusting bits to adjust the whole codes at byte units are inserted in the byte adjusting area.

On the other hand, the second compression section 1002-5 is an already known modified JPEG encoder and outputs the second compressed code 1002-15 (code length of JPEG code and JPEG code) in which a target code length supplied from the control section 1010 is adjusted at every block by using the code length information 1002-13 supplied from the first compression section 1002-3 and the low-resolution data 1002-14.

FIG. 6 is an explanation view explaining operations of the code synthesis section 1002-6 of the compressed section 1002 shown in FIG. 2. The code synthesis section 1002-6 converts the supplied first compressed code 1002-12 and the second compressed code 1002-15 into a prescribed code quantity (64 bytes in this example) to output it as the compressed data 1021. Accordingly, information of 16-byte×16-byte=256-byte is compressed into information of 64 bytes.

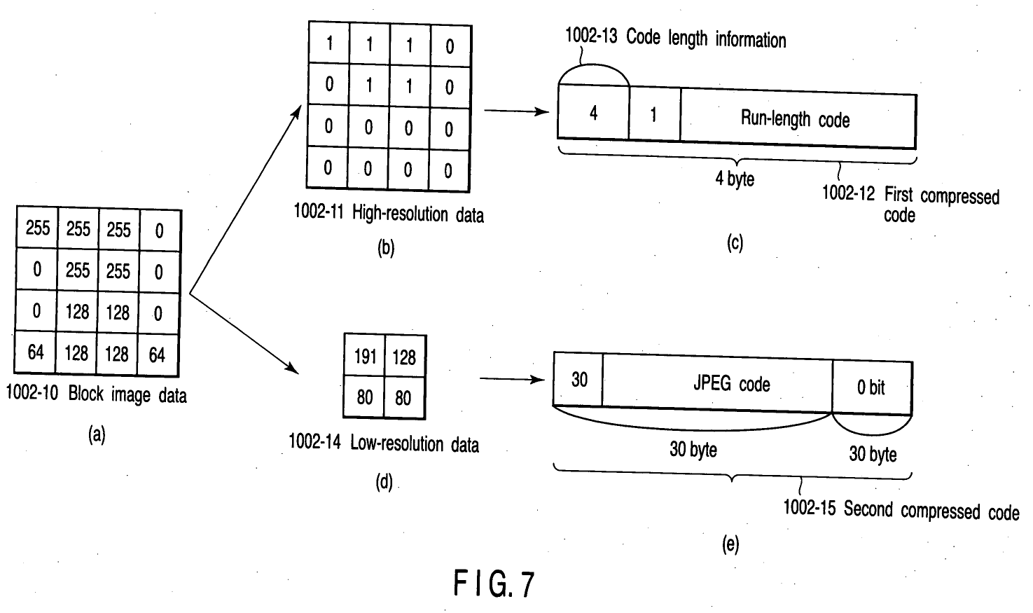

FIG. 7 shows a generation example of the compressed data 1021 generated from the compression section 1002 shown in FIG. 2. However, although the example will be described in 4×4 size for the purpose of simplification, operations are not different with each other. The input data has 16×16=256 bytes, so that compression rates for each block are compressed to ¼.

The block image data 1002-10 is shown at (a) of FIG. 7. The block image data 1002-10 is supplied to the high-resolution data extracting section 1002-2 to be converted into the high-resolution data 1002-11 as shown at (b) of FIG. 7. The high-resolution data 1002-11 is supplied to the first compression section 1002-3 to be compressed into the first compressed code 1002-12 shown at (c) of FIG. 7 and outputted. The block image data 1002-10 is supplied to the low-resolution conversion section 1002-4 to be converted into the low-resolution data 1002-14 as shown at (d) of FIG. 7. The low-resolution data 1002-14 is supplied to the second compression section 1002-5 and compressed into the second compressed code 1002-15 to be output as shown at (e) of FIG. 7. However, if both a JPEG code quantity and a run-length code quantity are lower than prescribed quantities, “0” for size adjustments are inserted by the quantity of 30 bytes.

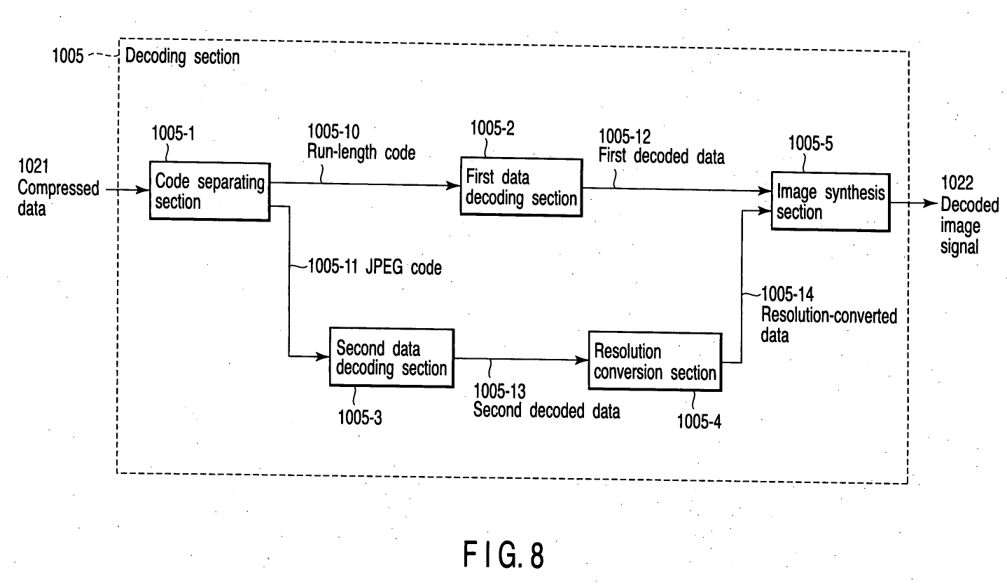

FIG. 8 shows a function composing the decoding section 1005 of the apparatus in FIG. 1 by dividing its function into blocks. The sections shown in FIG. 1 are put the same reference marks as those of FIG. 1.

The compressed data 1021 supplied to the decoding section 1005 is supplied to a code separating section 1005-1 in the decoding section 1005. The code separating section 1005-1 separates the compressed data 1021 into a run-length code 1005-10 and a JPEG code 1005-11. The run-length code 1005-10 is supplied to a first data decoding section 1005-2 and decoded to first decoded data 1005-12 to be output to an image synthesis section 1005-5. The JPEG code 1005-11 is supplied to a second data decoding section 1005-3 and decoded to second decoded data 1005-13 to be output to a resolution conversion section 1005-4.

The second decoded data 1005-13 supplied to the resolution conversion section 1005-4 is resolution-converted and output to the image synthesis section 1005-5 as the resolution-converted data 1005-14. The image synthesis section 1005-5 synthesizes the supplied first decoded data 1005-12 and the resolution-converted data 1005-14 to output the decoded image signal 1022.

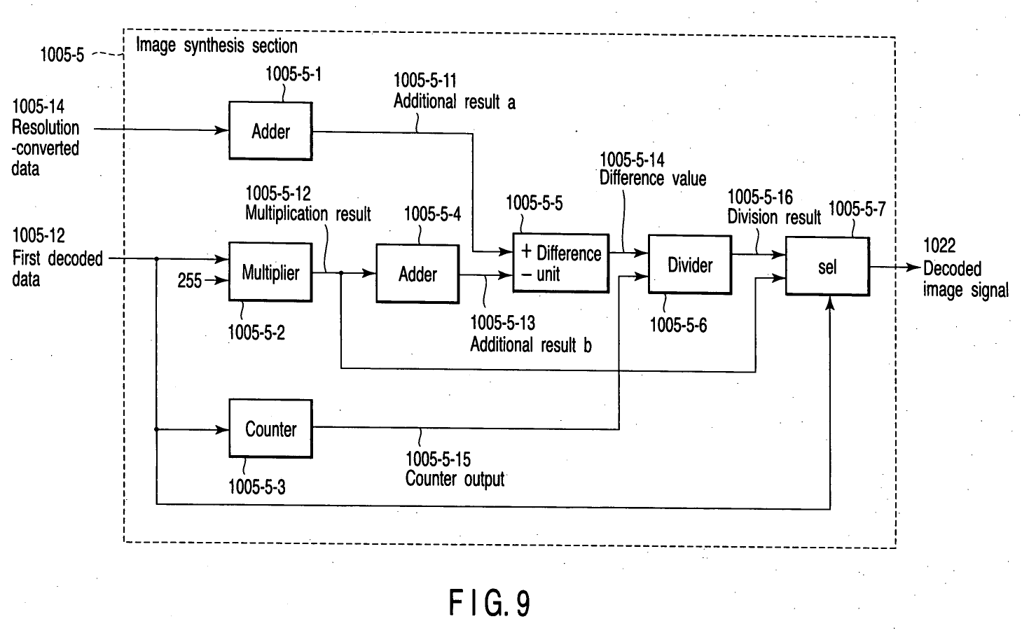

The first data decoding section 1005-2 composing the decoding section 1005 is a known run-length decoder, the second data decoder 1005-3 is a known JPEG decoder, and the resolution conversion section 1005-4 is an expander to simply expand a pixel twice, so that the image synthesis section 1005-5 composing a principal section of the present invention will be described by referring to FIG. 9.

FIG. 9 is a view showing the circuit configuration of the image synthesis section 1005-5 of the decoding section 1005 shown in FIG. 8. The image synthesis section 1005-5 operates for each unit having reduced resolution as one processing unit. That is to say, the resolution-converted data (low-resolution data) 1005-14 is supplied to an adder 1005-5-1 to be added in 2×2-pixel units and the addition result a 1005-5-11 is output to a difference unit 1005-5-5.

The first decoded data (high-resolution data) 1005-12 is supplied to a multiplier 1005-5-2 to be multiplied by “255”. That is, the input “0” is output as “0” and the input “1” is output as “255”. This multiplication result 1005-5-12 is added by 2×2-pixel unit by the adder 1005-5-4 and the addition result b 1005-5-13 is output to the difference unit 1005-5-5.

The difference unit 1005-5-5 subtracts the addition result b 1005-5-13 from the addition result a 1005-5-11 to output a differential value 1005-5-14. Here, the image synthesis section 1005-5 can obtain a signal value other than the pixel value reversibly compressed with a high resolution. Then, the signal value is clipped to “0” when the differential value becomes a minus value.

On the other hand, a counter 1005-5-3 counts the pixel of “0” of the high-resolution data 1005-12 at every 2×2-pixel area (at every processing) to output a counter output 1005-5-15. That is, the counter 1005-5-3 counts the number of the pixels of “0” in the 2×2-pixel area. A divider 1005-5-6 divides the output differential value 1005-5-14 by the counter output 1005-5-15. A division result 1005-5-16 is a pixel value of a non-high-resolution pixel.

If a high-resolution pixel value is “0”, a selector (sel) 1005-5-7 selects to output the division result 1005-5-16, and if the high-resolution pixel value is “1”, the selector (sel) 1005-5-7 selects the multiplication result 1005-5-12 (namely, “255”) to output it. The output from the selector 1005-5-7 is output as a composite image signal synthesized with a high-resolution.

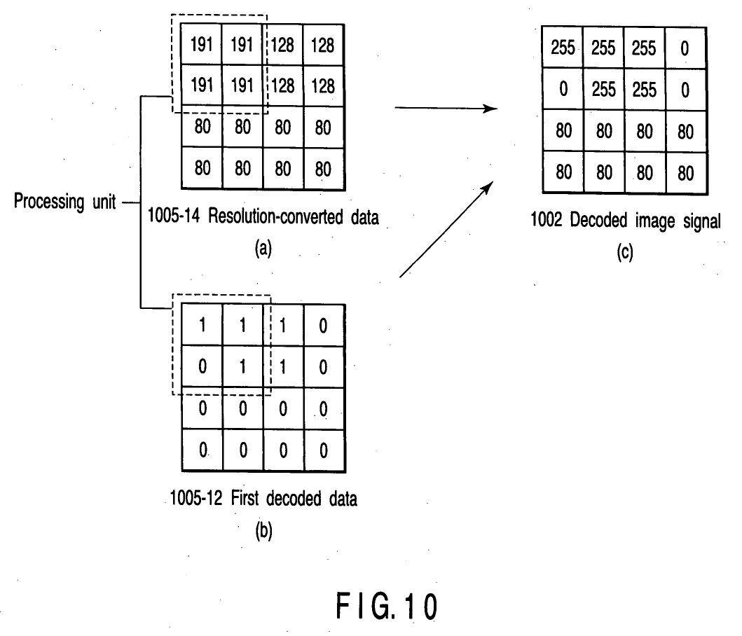

FIG. 10 shows examples of the resolution-converted data 1005-14, the first decoded data 1005-2 and the decoded image signal 1002 shown to explain operation examples of the image synthesis section 1005-5 shown in FIG. 9. However, for the simplification of the explanation, it is assumed that an image part to be explained is not deteriorated in image quality through the JPEG. The low-resolution compressed data 1002-14 shown at (d) of FIG. 7 is decoded into the low-resolution data 1005-14 at (a) of FIG. 10. The high-resolution data 1005-12 is shown at (b) of FIG. 10. The low-resolution data 1005-14 and the high-resolution data 1005-12 are synthesized into the decoded image signal 1022 shown at (c) of FIG. 10 by the operations described in FIG. 9.

At the (a) of FIG. 10, we focus attention on a processing unit surrounded by a dotted line. The adder 1005-5-1 quadruples “191” to output “746” as the addition result (a). On the other hand, at the processing unit for the corresponding high-resolution data 1005-12, one piece of “0” and three pieces of “1” are included. The multiplier 10050502 and the adder 1005-504 produce 255×3=765, respectively. In this case, since the difference is “−1” and a minus number, it is clipped to “0” to be output. On the other hand, the counter 1005-5-3 counts the pixel of “0” then “1” is output. Therefore, the multiplier 1005-5-6 performs (1/0) processing then outputs “0”. On the other hand, in the 2×2-pixel area being a processing unit, when the high-resolution data is “0”, the selector 1005-5-7 selects the output from the divider 1005-5-6, and when the high-resolution data is “1”, the selector 1005-5-7 selects the output from the multiplier 1005-5-2. Accordingly, within the area of the processing unit of the 2×2-pixel, data of “255”, “255”, “0”, and “255” is output from the image signal 10022. Even in the areas of other processing units, the same calculations as those of the above-mentioned processing units are performed.

The high-resolution image with 1,200 dpi, etc., has meaning to hold the high-resolution information by holding those values (black (255) and white (0)) at sites with the largest pixel value difference such as that between the values of black (255) and white (0). Accordingly, as described above, by maintaining the black pixel (255) by the reversible conversion, the merit in image quality of the increased-resolution data can be sufficiently obtained.

The above-described technique can obtain a higher compression rate than that obtained in plain compression of the image with 1,200 dpi and simply handle the compressed data by using a compression format in which a fixed data length is kept in block units.

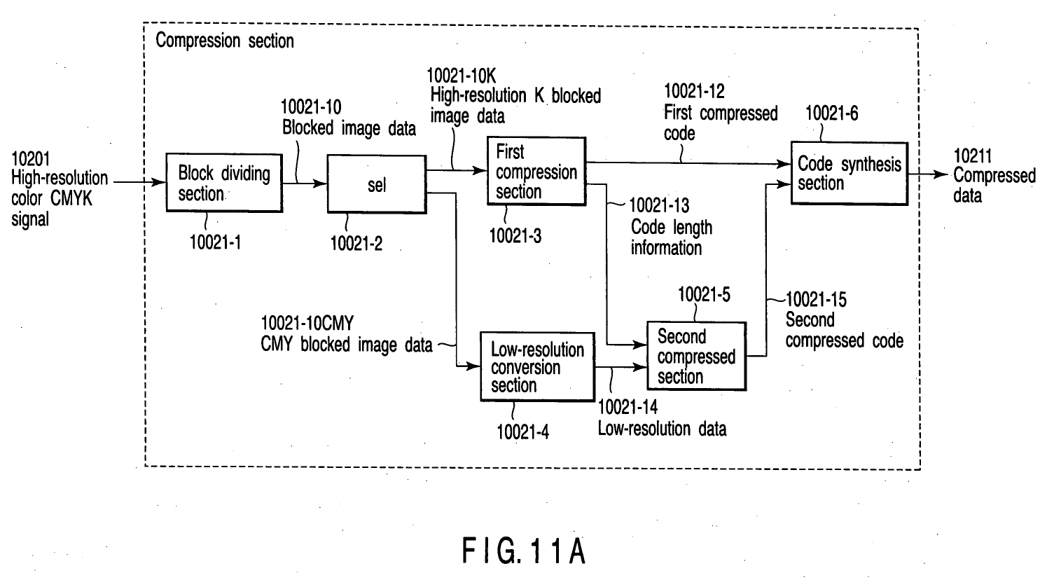

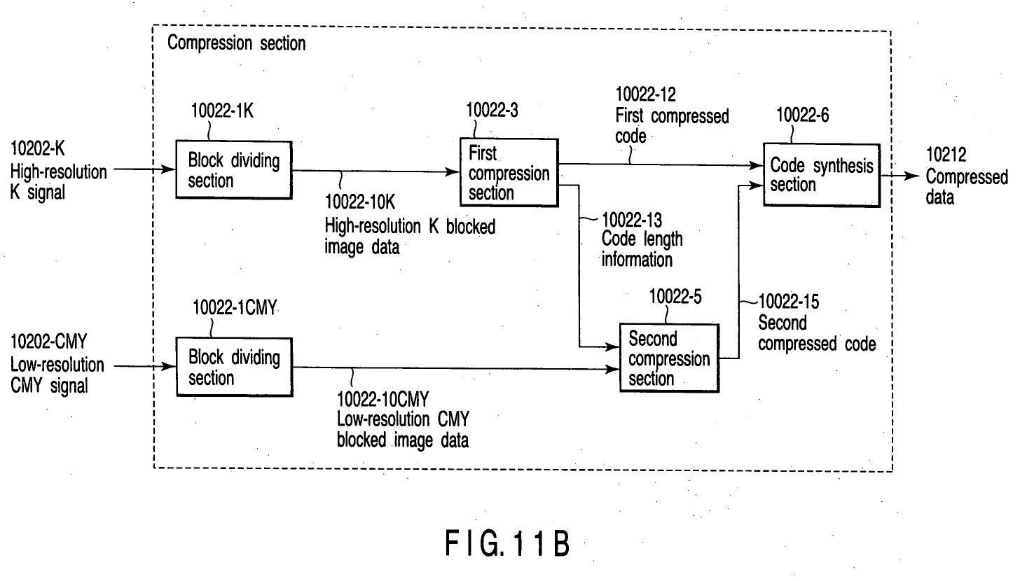

The present invention is not limited to the above-mentioned embodiments. In the forgoing example, 255-value of a monochrome image is handled reversibly as high-resolution information. However, the 255-value may be handled as shown in FIG. 11A or FIG. 11B.

FIG. 11A is a block diagram showing a configuration of a compression section regarding another embodiment of the present invention. A compression section 10021 shown in FIG. 11A is configured to compress only a K signal among a CMYK (C: cyan, M: magenta, Y: yellow, K: black) signal as the high-resolution information and compress it irreversibly together with CMY.

A high-resolution color CMYK signal 10201 supplied to the compression section 10021 is supplied to a block division section 10021-1 in the compression section 10021 and divided into 16×16 pixels to become blocked image data 10021-10, and the blocked image data 10021-10 is supplied to a selector 10021-2.

The selector 10021-2 divides the blocked image data 10021-10 into high-resolution K blocked image data 10021-10K related only to the K signal and CMY blocked image data 10021-10CMY related to the CMY signal.

A first compression section 10021-3 compresses the high-resolution K blocked image data 10021-10K and outputs a first compressed code 10021-12 to a code synthesis section 10021-6 and code length information 10021-13 to a second compression section 10021-5, respectively. The CMY blocked image data 10021-10CMY is supplied to a low-resolution conversion section 10021-4 to be converted into low-resolution data 10021-14 and output to the second compression section 10021-5. The second compression section 20021-5 generates a second compressed code 10021-15 on the basis of the supplied low-resolution data 1002-14 and the code length information 10021-13 to output it to the code synthesis section 10021-6. The code synthesis section 10021-6 synthesizes the supplied two compressed signals to output it as compressed data 10211.

FIG. 11B is a block diagram showing a configuration of a compression section regarding other embodiment of the present invention. A compression section 10022 shown in FIG. 11B is configured to compress only the K signal in the CMYK signal as high-resolution information and compress the CMY signal therein as low-resolution information.

A high-resolution K signal 10202-K and a low-resolution CMY signal 10202-CMY are supplied to the compression section 10022. The high-resolution K signal 10202-K is supplied to a block division section 10022-1K, divided into 16×16 pixels and output to a first compression section 10022-3 as high-resolution K blocked image data 10022-10K. The low-resolution CMY signal 10202-CMY is supplied to a block division section 10022-1CMY, divided into 16×16 pixels and output to a second compression section 10022-5 as low-resolution CMY blocked image data 10022-10CMY. The high-resolution K blocked image data 10022-10K is compressed by the first compression section 10022-3 and outputs a first compressed code 10022-12 to a code synthesis section 10022-6 and code length information 10022-13 to a second compressed section 10022-5, respectively. A second compression section 10022-5 outputs a second compressed code 10022-15 to the code synthesis section 10022-6 on the basis of the supplied low-resolution CMY blocked image data 10022-10CMY and the code length information 10022-13. The code synthesis section 10022-6 synthesizes the supplied two compressed codes to output it as compressed data 10212.

Therefore, if this invention is used in a 4-rotation engine, when compressing a CMY (low-resolution) K (high resolution) signal, this invention may supply only data of a color signal required by the engine. If the K signal or the CMY signal is required, it is enough for the invention to transfer only each data related to each signal to an image processing section.

According to the above-mentioned method, the compression section does not decide a code quantity of the low-resolution data on the basis of a compressed size and a targeted code quantity of the low-resolution data but can decide sizes of targets for each high and low-resolution data, respectively. Then, if necessary, the method can mix reversible and irreversible compressions for both high and low-resolution data and decide independently maximum transfer rates of both high and low-resolution-compressed data. Therefore, the maximum transfer rate of a system becomes smaller than when the C, M, Y, and K signals are transferred all together, so that the system is reduced in cost.

Compressed data is decided at high and low-resolutions, respectively. Therefore, for example, in the code synthesis section, even if additional information on a size adjustment is deleted and the compressed data is output as variable length data, the maximum transfer rate is satisfied. Accordingly, the data handling is not changed in convenience, and the number of storage media with the data stored thereon can be increased.

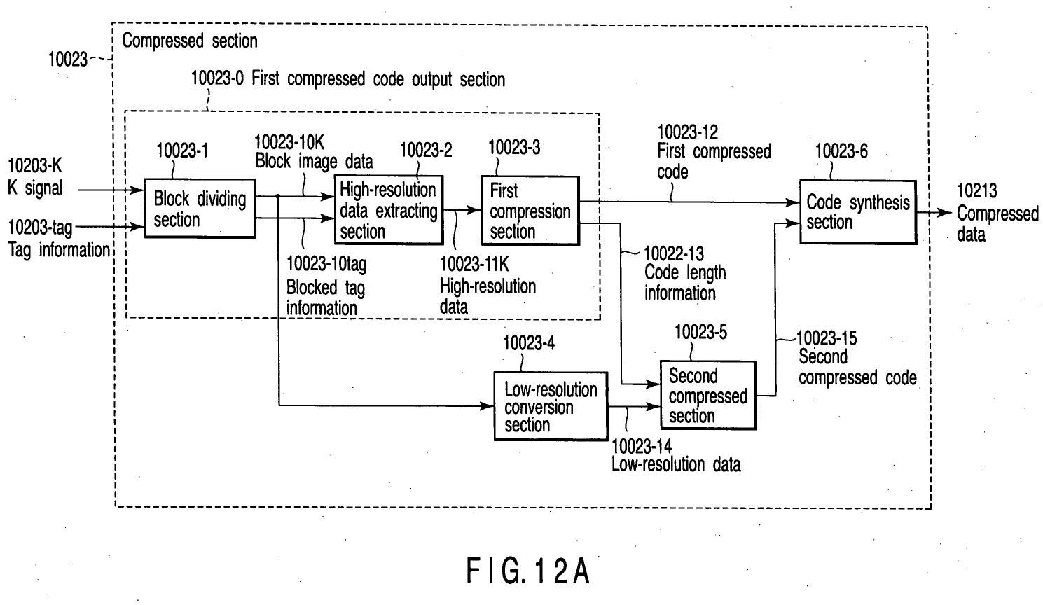

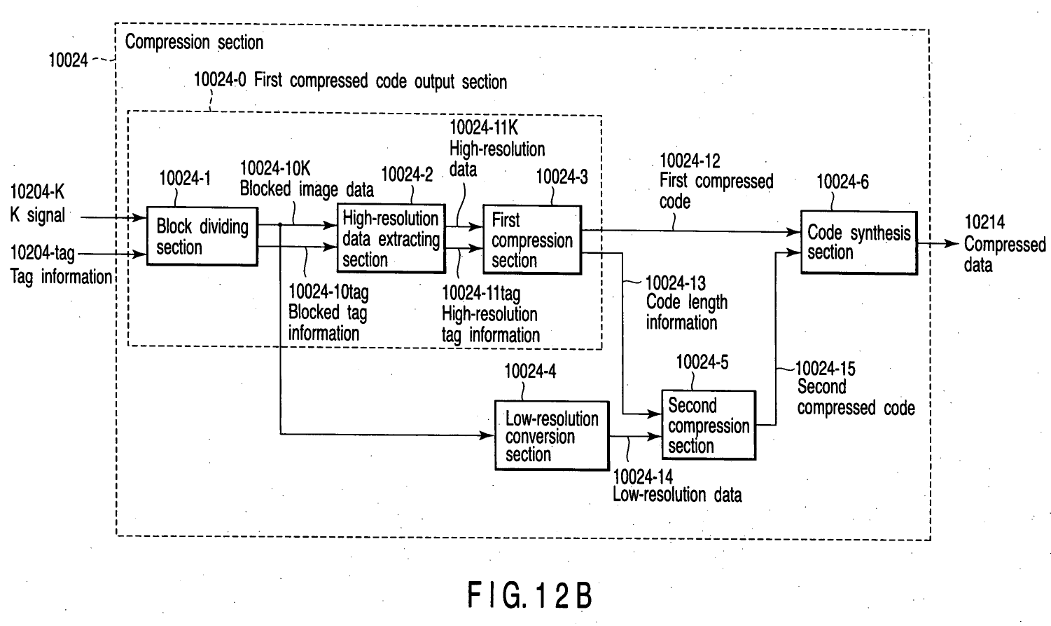

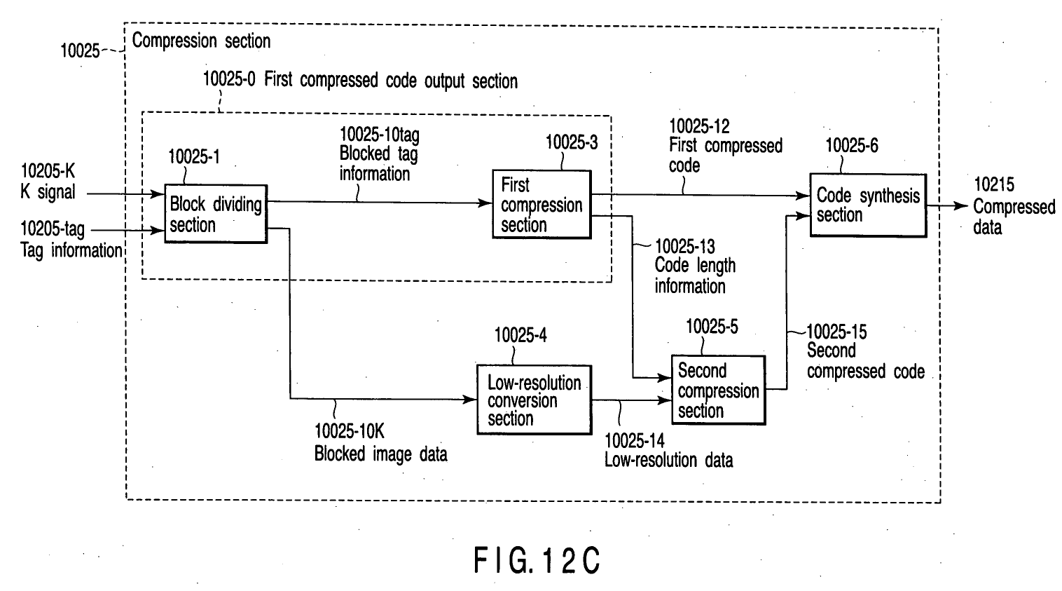

This invention is not limited to the embodiments described above. In the case of identifying images by means of a known identification technique or in the case of outputting images by means of a known printer, the invention may process the data as shown in FIG. 12A, FIG. 12B or FIG. 12C. The compression sections in FIG. 12A, FIG. 12B and FIG. 12C are the same as that of the compression section 1002 already described for FIG. 2 except for a first compressed code output section, so that only the first compressed code output section will be described.

FIG. 12A is a block diagram showing a configuration of a compression section regarding other embodiment of the present invention. A compression section 10023 shown in FIG. 12A is configured to select and compress image data to be compressed with a higher resolution on the basis of tag information (also termed as feature information or attribute information).

A K-signal 10203-K and tag information 10203-tag is supplied to the compression section 10023. The K-signal 10203-K and the tag information 10203-tag is supplied to a block dividing section 10023-1 to be divided into 16×16 pixels. K blocked image data 10023-10K is supplied to a high-resolution data extraction section 10023-2 and a low-resolution conversion section 10023-4. Blocked tag information 10023-10tag is supplied to the high-resolution data extracting section 10023-2.

The high-resolution data extracting section 10023-2 converts the K-blocked image data 10023-10K into high-resolution data 10023-11K on the basis of the supplied blocked tag information 10023-10tag and outputs it to a first compression section 10023-3. The first compression section 10023-3 compresses the supplied high-resolution data 10023-11K to output a first compressed code 10023-12. The block dividing section 10023-1, the high-resolution data extracting section 10023-2 and the first compression section 10023-3 compose a first compressed code output section 10023-0.

FIG. 12B is a block diagram showing a configuration of a compression section regarding other embodiment of the present invention. A compression section 10024 shown in FIG. 12B is configured to compress tag information and image data together.

A K-signal 10204-K and tag information 10204-tag is supplied to the compression section 10024. The K-signal 10204-K and tag information 10204-tag is supplied to a block dividing section 10024-1 to be divided into 16×16 pixels. K-blocked image data 10024-10K is supplied to a high-resolution data extracting section 10024-2 and a low-resolution conversion section 100274-4, and blocked tag information 10024-10tag is supplied to the high-resolution data extracting section 10024-2.

The high-resolution data extracting section 10024-2 converts the K-blocked image data 10024-10K into high-resolution tag information 10024-tag on the basis of the supplied blocked tag information 10024-10tag and converts the blocked tag information 10024-10tag into high-resolution tag information 10024-11tag to output it to a first compression section 10024-3. The first compression section 10024-3 compresses the supplied high-resolution data 10024-11K and the high-resolution tag information 10024-11tag and outputs a first compressed code 10024-12. The block dividing section 10024-1, the high-resolution data extracting section 10024-2 and the first compression section 10024-3 compose a first compressed code output section 10024-0.

FIG. 12C is a block diagram showing a configuration of a compression section regarding other embodiment of the present invention. A compression section 10025 is configured to compress tag information and image data together.

A K-signal 10205-K and tag information 10205-tag is supplied to the compression section 10025. The K-signal 10205-K and the tag information 10205-tag is supplied to a block dividing section 10025-1 to be divided into 16×16 pixels. Blocked tag information 10025-10tag is output to a first compression section 10025-3 and K-blocked image data 10025-10K is output to a low-resolution conversion section 10024-4, respectively.

The first compression section 10025-3 compresses the supplied blocked tag information 10025-10tag to output a first compressed code 10025-12. The block dividing section 10025-1 and the first compression section 10025-3 composes a first compressed code output section 10025-0.

Therefore, this invention can recover a character format from high-resolution tag information even an image is made at a lower resolution, when the tag information is generated while expressing the character format. The invention can select data expected to be compressed with a higher resolution even when the tag information to be supplied is generated with a higher resolution different from that of the image. Furthermore, the invention also can extract information on the character format or the like by using both of the tag information and the image.

In addition, when performing composite (or synthesis) compression to data with different kinds of resolutions by utilizing block-encoding, the invention can convert a part of blocked and coded data into block-composite (or synthesized) compressed data without completely decoding it if a resolution, a processing block size and a targeted compression rate of entire data are satisfied.

Furthermore, in run-length compression processing, as long as a reversible pixel value is prepared as a code value, the invention can compress data other than 255-value data. Having used binary compression, this invention can compress a target to be compressed, for example, by expanding it to three values of “0”, “255” and other.

The invention is not limited to the configurations of the above-mentioned embodiments. The forgoing embodiments are described by focusing attention on relations between two kinds of resolutions such as high resolution (for example, 1,200 dpi) and low resolution (for example, 600 dpi) and characters. However, the invention can compress data, even when a signal with a high resolution, a signal with a low resolution and a signal with other third resolution are mixed on the data.

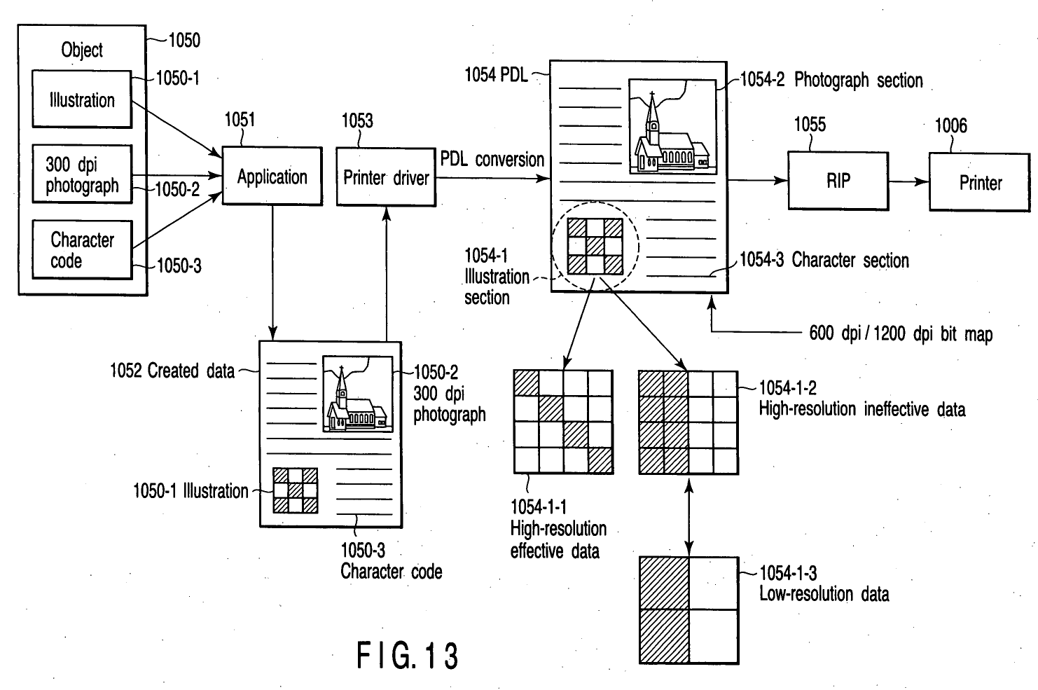

FIG. 13 is an explanation view showing operations in outputting of print data composed of data with a various kinds of resolutions.

A reference numeral 1050 denotes an object 1050 for creating image data to be output. A user can edit an illustration 1050-1, a 300-dpi photograph 1050-2 and a character code 1050-3 by means of an application 1051. The application 1051 outputs edited and created data 1052 to a printer driver 1053. The created data 1052 supplied to the printer driver 1053 is converted into, for example, a printer description language (PDL) with 600 dpi/1,200 dpi loaded on a printer 1006 and output to routing information protocol (RIP) 1055.

The RIP 1005 transmits the supplied PDL 1054 to the printer 1006 to output the PDL 1054. In the PDL 4054 created here, a photograph section 1054-2 in which low-resolution data is expanded and created in accordance with an output resolution like the 300-dpi photograph 1050-2 and a character section 1054-3 in which the low-resolution data is increased in resolution like the character code 1050-3 are mixed. The PDL 1054 with high-resolution rendering allied thereto is created in higher quality by reversible compression, but, the PDL 1054 is separated into high-resolution effective data 1054-1-1 effective in increasing its resolution and high-resolution ineffective data 1054-1-2 having no difference from the case of decreasing of its resolution even when the resolution is increased.

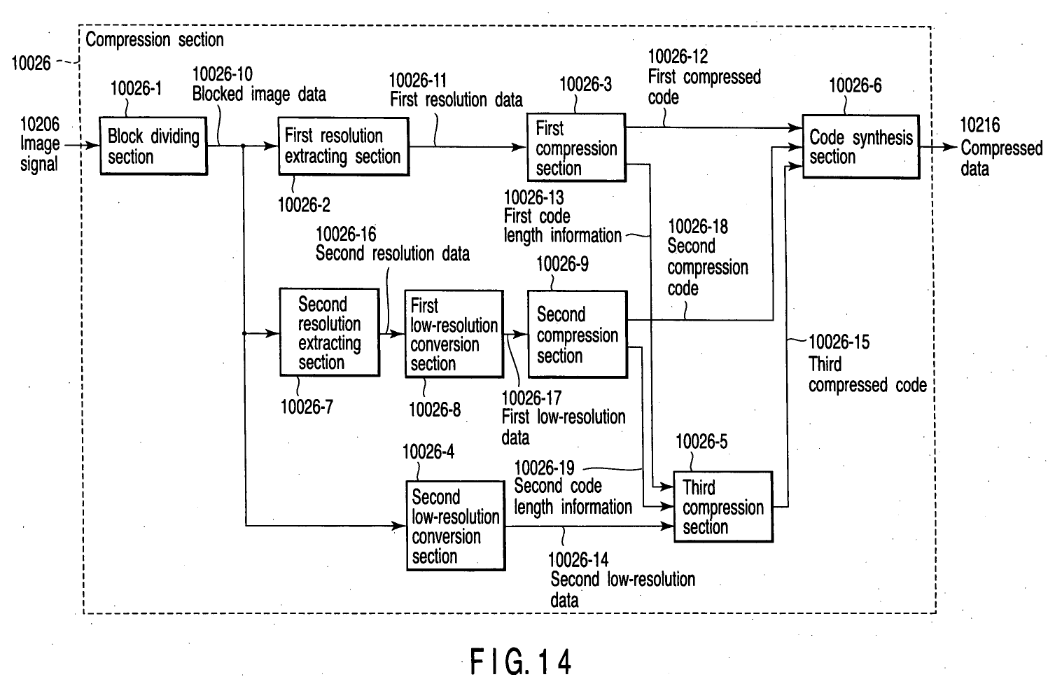

FIG. 14 shows blocked functions of a compression section 10026 for achieving the processing described for FIG. 13.

An image signal 10206 supplied to the compression section 10026 is supplied to a block dividing section 10026-1 in the compression section 10026, divided into 16×16 pixels and output as blocked image data 10026-10. The blocked image data 10026-10 supplied to a first resolution extracting section 10026-2 is converted into first resolution data 10026-12 of 1,200 dpi and supplied to a first compression section 10026-3. The blocked image data 10026-10 supplied to a second resolution extracting section 10026-7 is converted into second resolution data 10026-16 of 600 dpi and supplied to a first low-resolution conversion section 10026-8.

The second resolution data 10026-16 supplied to the first low-resolution conversion section 10026-8 is converted into first low-resolution data 10026-17 and supplied to a second compression section 10026-9. The blocked image data 10026-10 supplied to a second low-resolution conversion section 10026-4 is converted into second low-resolution data 10026-14 of 300 dpi and supplied to a third compression section 10026-5.

The first compression section 10026-3 reversibly compresses the supplied first resolution data 10026-11 to output a first compressed code 10026-12 to a code synthesis section 10026-6 and output first code length information 10026-13 to the third compression section 10026-5, respectively. The second compression section 10026-9 reversibly compresses the supplied first low-resolution data 10026-17 to output a second compressed code 10026-18 to the code synthesis section 10026-6 and output second code length information 10026-19 to the third compression section, respectively. The third compression section 10026-5 irreversibly compresses the supplied second low-resolution data 10026-14, based on the first code length information 10026-13 and the second code length information 10026-19 to supply a third compressed code 10026-15 to the code synthesis section 10026-6. The code synthesis section 10026-6 synthesizes the supplied three compressed codes to output it as compressed data 10216.

As above-described embodiment, the data is configured to compress the high-resolution data reversibly and further separate the low-resolution data into reversible (or lossless) compression and irreversible compression after decreasing its resolution, and also make the low-resolution data different in resolution at the reversible compression and the irreversible compression. Thereby, the embodiment can process the supplied image signal even when the signal decreased in resolution is mixed therein and further compress the signal.

In such a case, having described by setting the relation between the high-resolution and the low-resolution to 2N times, it is possible to set to other multiplying relations. And the resolutions in performing compression are not limited to the resolutions in the embodiments. For example, in an RGB signal, if the values of RGB are equal with one another (in the case of black or gray), it is possible to extract an image as high-resolution target data and extract it on the basis of the known identification technique.

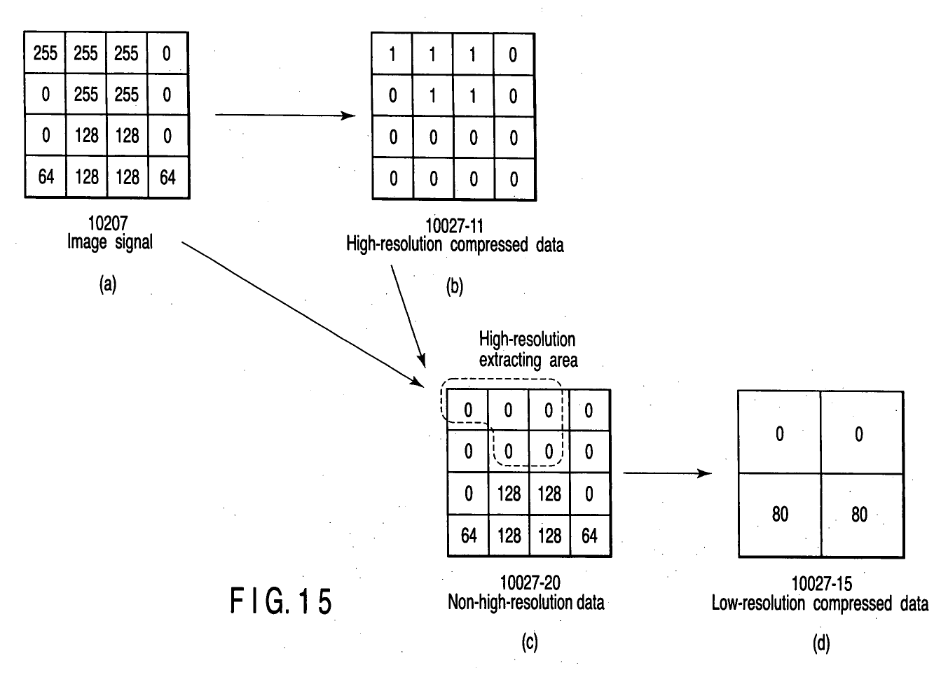

This invention is not limited to a manner of the embodiments mentioned above. In the forgoing embodiments, having processed the high-resolution signal and the low-resolution signal individually, even the configuration, as shown in FIG. 15, to displace a pixel value area extracted as high-resolution data can obtain low-resolution compressed data.

FIG. 15 is an explanation view explaining operations of a compression section 10027 regarding other embodiment of the present invention. At (a) in FIG. 15, an image signal 10207 input to the compression section 10027 is shown. High-resolution data is extracted form the image signal 10207 and compressed to high-resolution compressed data 10027-11 shown in (b) of FIG. 15. The high-resolution data is extracted from the image signal 10207 to be compressed to high-resolution compressed data 10027-11 shown at (b) in FIG. 15. In the image signal 10207, the pixel value area extracted as high-resolution data is displaced to “0” as shown in (c) of FIG. 15 and extracted as non-high-resolution data 10027-20. Next, in the non-high-resolution data 10027-20, surrounding non-high-resolution pixel values, for example, non-high-resolution pixel values in a 2×2 pixels processing unit are averaged and the non-high-resolution data 10027-20 is compressed to low-resolution data as shown in (d) of FIG. 15. According to this embodiment, the encoding efficiency for compression with a low-resolution can be improved.

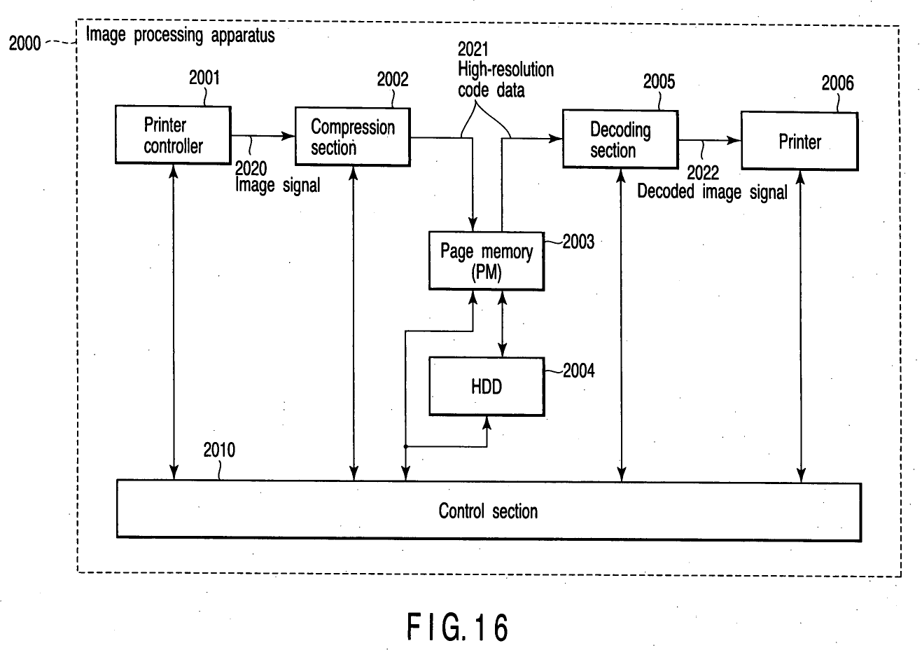

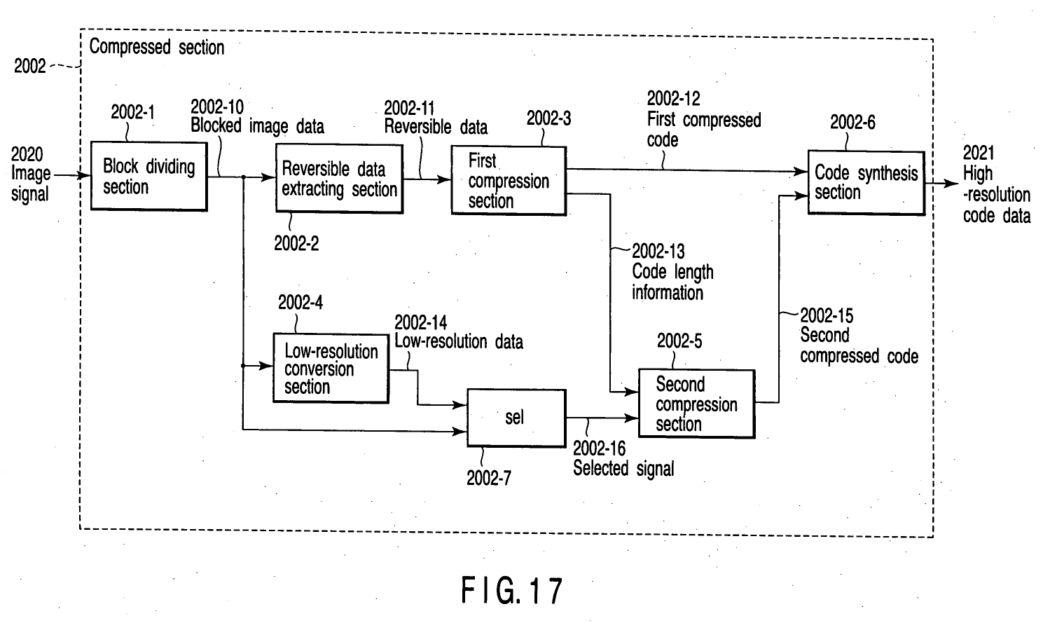

FIG. 16 shows a function composing an image processing apparatus 2000 regarding other embodiment of the present invention by dividing the function into blocks. Since sections other than a compression section 2002 are the same as those of the first embodiment, only the compression section 2002 will be described by referring to FIG. 17.

FIG. 17 is a block diagram showing a configuration of the compression section 2002 of the image processing apparatus shown in FIG. 16. The basic configuration is similar to those of the compression section 1002 of the first embodiment, but greatly different from the first embodiment in a point of addition of a selector 2002-7.

An image signal 2020 with 1,200 dpi input from a printer controller 2001 is supplied to a block dividing section 2002-1 to be extracted by 16×16-pixel units. This output is blocked image data 2002-10. A reversible data extracting section 2002-2 separates the supplied blocked image data 2002-10 into a 255-pixel value and other information and outputs reversible data 2002-11. A first compression section 2002-3 compresses the supplied reversible data 2002-11 to supply a first compressed code 2002-12 to a code synthesis section 2002-6 and supply code length information 2002-13 to a second compression section 2002-5. A low-resolution conversion section 2002-4 converts the supplied blocked image data of 1,200 dpi into image data with a resolution of 600 dpi to output low-resolution data 2002-14 and this data is supplied to a selector 2002-7. The selector 2002-7 selects either one data of the supplied blocked image data 2002-10 of 1,200 dpi or the supplied low-resolution data 2002-14 of 600 dpi to output a selected signal 2002-16. The second compression section 2002-5 compresses the selected signal 2002-16 on the basis of the supplied code length information 2002-13 to create a second compressed code 2002-15 and supplies the second compressed code 2002-15 to the code synthesis section 2002-6. The code synthesis section 2002-6 synthesizes the supplied first compressed code 2002-12 and first compressed code 2002-15 to output high-resolution code data 2021.

In this case, although the image signal 2020 supplied from the printer controller 2001 is explained as the image signal 2020 of 1,200 dpi, the image signal 2020 is not limited to this case. When the image signal 2020 of 600 dpi is supplied from the printer controller 2001, the block dividing section 2002-1 extracts the image signal 2020 by 8×8-pixel unit. The reversible data extracting section 2002-2 extracts the reversible data 2002-11 by the same processing as that described above except for the difference in size to be handled. And the reversible data 2002-11 is compressed by means of the first compression section.

The selector 2002-7 selects blocked image data 2002-10 on the basis of the control information from the control section 2010 to supply it as the selected signal 2002-16 to the second compression section 2002-5. In this case, the code synthesis section 2002-6 outputs usual-resolution code data 2021-1.

As mentioned above, by setting target code quantities of the second compression section to the same quantities even in both cases of 1,200 dpi and 600 dpi, the supplied image signal can be handled as the compressed data having the same data quantity regardless of resolutions, so that code data becomes easy to be handled. When the target code quantity is set to smaller one when the resolution of the image data converted into 600 dpi, the compression section 2002 can compress the image data appropriately to 1,200 dpi/600 dpi without having to extremely change an encoder. Furthermore, in the relation of target code quantities between the image data of 1,200 dpi and 600 dpi, the quantity for 1,200 dpi has become double of 600 dpi. According to the configuration as described above, for example, even if the image data both 1,200 dpi and 600 dpi are mixed on a page memory, the image signal can be simply handled. Since the data quantity is decreased by half against four times of an original data quantity, larger effects of compression can be expected.

As described above, this invention is specified by the following constituent sections (1a)-(1f). That is to say,

(1a) a block dividing section 1002-1 for dividing an image into blocks to output blocked image data;

(1b) an extracting section 1002-2 for extracting high-resolution data from the blocked image data;

(1c) a first compression section 1002-3 for compressing the high-resolution data;

(1d) a low-resolution conversion section 1002-4 for converting the blocked image data into low-resolution data;

(1e) a second compression section 1002-5 for compressing the low-resolution data; and

(1f) a code synthesis section 1002-6 for synthesizing first compressed data from the first compression section and second compressed data from the second compression section 1002-5 as a single piece of compressed data. Thereby, the image is made to the single piece of compressed data with a high-resolution or a low-resolution, so that the invention handles data simply, and since the invention extracts the data, the compression efficiency is improved.

(2) In addition to the above-described basic sections, the invention limits a resolution-conversion compression system and the first compression section and the second compression section use different compression systems with each other. Therefore, the invention utilizes compression system in response to high or low resolutions, so that the compression efficiency is improved.

(3) In addition to the above-described basic sections, the invention limits the resolution-conversion compression system, the first compression section reversibly compresses and the second compression section irreversibly compresses. Therefore, the compression by increasing its resolution is performed reversibly and the compression by decreasing its resolution is preformed irreversibly, and the image is compressed in accordance with resolution information, so that the compression efficiency is improved.

(4) In addition to the above-described basic sections, this invention limits fixed data length and the code synthesis section 1002-6 outputs output compressed data with a fixed data length. Since the invention can handle the compressed data as the fixed length data, the compressed data can be handled simply.

(5) In addition to the above-mentioned basic sections, the invention limits the fixed data at every resolution and first compressed data from the first compression section and second compressed data from the second compression section has the fixed data lengths, respectively. Therefore, fixed data lengths are set for each resolution, so that the compressed data are easy to be handled.

(6) In addition to the above-mentioned basic sections, the invention recognizes the importance whether the image signal is a color signal or a monochrome signal, the block dividing section divides a CMYK image signal including cyan (c), magenta (M), yellow (Y) and black (K) signals into blocks and the low-resolution conversion section decrease resolutions of the C, M, Y signals. Therefore, since the K signal of which the resolution is foremost important among color data can be kept high in resolution, the image quality is improved.

(7) In addition to the above-described basic sections, the invention uses feature information and the extracting section (1002-2) further extracts attribute information other than the high-resolution data. That is, since the invention performs resolution determination by using information on tag, etc., the accuracy is improved.

(8) In addition to the above-described basic sections, the invention performs three-step compression processing and the low-resolution conversion section is the first low-resolution conversion section 10026-4 for converting the blocked image data into the first low-resolution data. Furthermore, the compression section 10026 has the second extracting section 10026-7 for extracting second high-resolution data from the blocked image data; the second low resolution conversion section 10026-8 for converting the second high-resolution data into second low-resolution data; and the third compression section 10026-9 for compressing the second low-resolution data. And the code synthesis section synthesizes a first compressed data, a second compressed data and a third compressed data from the first, the second and the third compression sections, respectively, into a single piece of compressed data.

The invention according to the foregoing description of (8) can handle the resolutions in a multistage manner and all together, the compression rate is enhanced.

The invention is specified the following sections (9a)-(9f). That is to say, the invention comprises:

(9a) a block dividing section for diving an image into blocks and output blocked image data;

(9b) an extracting section extracting high-resolution data from the blocked image data;

(9c) a first compression section for compressing the low-resolution data;

(9d) a low-resolution conversion section for converting the high-resolution data into low-resolution data;

(9e) a second compression section for compressing the low-resolution data; and

(9f) a code synthesis section for synthesizing first compressed data from the first compression section and second compressed data from the second compression section into a single piece of compressed data.

In the sections (9a)-(9f), since the invention handles the low-resolution data which is corrected on the basis of the high-resolution extracted data, the compression rate and image quality are improved.

This invention is specified the following sections (10a)-(10h). That is, the invention comprises:

(10a) the block dividing section 1002-1 for dividing an image into blocks to output blocked image data;

(10b) the extracting section 1002-2 for extracting high-resolution data from the blocked image data;

(10c) the first compression section 1002-3 for compressing the high-resolution data;

(10d) the low-resolution conversion section 1002-4 for converting the blocked image data into low-resolution data;

(10e) the selector 2007-7 for selecting either one of the blocked image data or the low-resolution data;

(10f) the second compression section 1002-5 for compressing output data from the selector;

(10g) the code synthesis section 1002-6 for synthesizing first compressed data from the first compression section and second compressed data from the second compression section into a single piece of compressed data; and

(10h) the control section for making the selector select a blocked image when the second compression section compresses at the same resolution as that of the first compression section and select a reduced resolution image when the second compression section compresses the low-resolution image.

According to the above-mentioned sections (10a)-(10h), the invention can achieve a high-resolution image needed to be resolution-converted and an image having a lower resolution are obtained by almost same compression systems and make its application field wide.

(11) According to the invention, in addition to the above-described basic sections (10a)-(10h), the code synthesis section handles compressed data having a size with fixed data lengths and not varying even when the second compression section selects the blocked image and even when the second compression section selects the low-resolution image. At this time, the code synthesis section can handle the image needed to be converted with multiple resolutions and the compressed data not needed to be converted therewith in the same manner, so that the code synthesis section can simply handle the image.

(12) According to the invention, in addition to the above-described sections (10a)-(10h), the code synthesis section handles the compressed data having a size with fixed data lengths and having a data quantity of 2N times at the time when the second compression section selects the low-resolution image in comparison to the time when the second compression section selects the blocked image. In this case, since the code synthesis section can handle the image requiring the multiple resolution conversion and the compressed data not requiring the multiple resolution conversion by a multiple of 2 in data size, the compressed data can be handled simply.

According to above-mentioned means, the present invention can efficiently compress data by identifying between the data which is needed to be held in a high-resolution and the data which is not needed to be held therein. And the invention synthesizes high-resolution data and low-resolution data into separable single item of compressed data, so that the data can be handled simply and the compression rate is also improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image data compressing apparatus, comprising:
a block dividing section which divides an image unto blocks and outputs blocked image data;
an extracting section which extracts high-resolution data from the blocked image data;
a first compression section which compresses the high-resolution data;
a low-resolution conversion section which converts the blocked image data into low-resolution data;
a second compression section which compresses the low-resolution data; and
a code synthesis section which synthesizes first compressed data from the first compression section and second compressed data from the second compression section into a single piece of compressed data.

2. The image data compressing apparatus according to claim 1, wherein the first compression section and the second compression section use different compression systems with each other.

3. The image data compressing apparatus according to claim 1, wherein the first compression section performs reversible compression processing and the second compression section performs irreversible compression processing.

4. The image data compressing apparatus according to claim 1, wherein the code synthesis section outputs output compressed data in a fixed data length.

5. The image data compressing apparatus according to claim 1, wherein the first compressed data from the first compression section and the second compressed data from the second compression section has fixed data lengths, respectively.

6. The image data compressing apparatus according to claim 1, wherein
the block dividing section divides a CMYK image signal including cyan (c), magenta (M), yellow (Y) and black (K) signals into blocks;
the first compression section performs compression processing for the K signal
the low-resolution conversion section decreases resolutions of the C, M, Y signals.

7. The image data compressing apparatus according to claim 1, wherein the extracting section further extracts attribute information other than the high-resolution data.

8. The image data compressing apparatus according to claim 1, wherein
the low-resolution conversion section is a first low-resolution conversion section which converts the blocked image data into first low-resolution data, furthermore, the conversion section has
a second extracting section which extracts second high-resolution data from the blocked image data;
a second low resolution conversion section which converts the second high-resolution data into second low-resolution data; and
a third compression section which compresses the second low-resolution data, and
the code synthesis section synthesizes the first compressed data, the second compressed data and a third compressed data from the first, the second and the third compression sections, respectively, into a single piece of compressed data.

9. The image data compressing apparatus according to claim 1, wherein the low-resolution conversion section converts the high-resolution data into low-resolution data.

10. An image compressing apparatus, comprising:
a block dividing section which divides an image into blocks and outputs blocked image data;
an extracting section which extracts high-resolution data from the blocked image data;
a first compression section which compresses the low-resolution data;
a low-resolution conversion section which converts the blocked image data into low-resolution data;
a selector which selects either one of the blocked image data or the low-resolution data;
a second compression section which compresses output data from the selector;
a code synthesis section which synthesizes first compressed data from the first compression section and second compressed data from the second compression section into a single piece of compressed data; and
a control section which makes the selector select a blocked image when the second compression section performs compression with the same resolution as that of the first compression section and select a low-resolution image when the second compression section compresses an image with a low-resolution.

11. The image data compressing apparatus according to claim 10, wherein the code synthesis section handles each compressed data having a size of a fixed data length and not varying the size when the second compression section selects the blocked image and also when the second compression section selects the low-resolution image.

12. The image data compressing apparatus according claim 10, wherein the code synthesis section handles each compressed data having a size with a fixed data length and having a data quantity of 2N times at the time when the second compression section selects the low-resolution image.

13. An image data compressing method having a block dividing section, an extraction section, a first compressing section, a low-resolution conversion section, a second compression section, a code synthesis section and a control section which controls operations, comprising:
dividing an input image into blocks to output blocked image data by means of the block dividing section;
extracting high-resolution data from the blocked image data by means of the extracting section;
compressing high-resolution data by means of the first compression section;
converting the blocked image data into low-resolution data by means of the low-resolution conversion section;
compressing the low-resolution data by means of the second compression section; and
synthesizing first compressed data from the first compression section and second compressed data from the second compression section as a single piece of compressed data by means of the code synthesis section.

14. The image data compressing method according to claim 13, wherein the first compression section and the second compression section use different compression systems with each other, furthermore, the first compression section performs reversible compression processing and the second compression section performs irreversible compression processing,
the first compressed data from the first compression section and the second compressed data from the second compression section respectively have fixed data lengths and output compressed data from the code compression section also has a fixed data length.

15. The image data compressing method according to claim 13, wherein
the block dividing section divides a CMYL image signal including cyan (C), magenta (M), yellow (Y) and black (K) signals;
the first compression section compresses the K signal; and
the low-resolution conversion section decrease resolutions of the C, M, and Y signals.

16. The image data compressing method according to claim 13, wherein the extracting section further extracts attribute information other than the high-resolution data.

17. The image data compressing method according to claim 13, wherein
the low-conversion conversion section
converts the blocked image data into first low-resolution data;
extracts second high-resolution data from the blocked image data;
converts the second high-resolution data into second low-resolution data; and
compresses the second low-resolution data by means of a third compression section, and
the code synthesis section synthesizes the first compressed data, the second compressed data and third compressed data from the first, the second and the third compression sections, respectively, into a single piece of compressed data.
